(19) United States
(12) Patent Application Publication
(10) Pub. No.: US 2022/0248730 A1
(43) Pub. Date: Aug. 11, 2022

(54) Multi-Purpose Ingredient for Bakery and Other Products

(71) Applicants: Loren S. Ward, Twin Falls, ID (US); Diane W. Hoffpauer, Twin Falls, ID (US); Angela Dunn Mascio, Anaheim, CA (US); Jason Demmerly, Kimberly, ID (US); Loretta Martins, Kimberly, ID (US); Melinda Moss, Twin Falls, ID (US); Michael Young, Kimberly, ID (US)

(72) Inventors: Loren S. Ward, Twin Falls, ID (US); Diane W. Hoffpauer, Twin Falls, ID (US); Angela Dunn Mascio, Anaheim, CA (US); Jason Demmerly, Kimberly, ID (US); Loretta Martins, Kimberly, ID (US); Melinda Moss, Twin Falls, ID (US); Michael Young, Kimberly, ID (US)

(21) Appl. No.: 16/904,514

(22) Filed: Jun. 17, 2020

Related U.S. Application Data
(63) Continuation of application No. 14/148,722, filed on Jan. 6, 2014, now abandoned.
(60) Provisional application No. 61/749,376, filed on Jan. 6, 2013.

(51) Int. Cl. A23L 15/00; A21D 2/26

(52) U.S. Cl. CPC A23L 15/35; A21D 2/263; A23V 2002/00; A23V 2200/122; A21D 2/266

(57) ABSTRACT

Disclosed are multi-functional compositions for use as egg replacers, or egg substitutes, as well as binders, coatings, washes, emulsifiers, and fat replacers. These compositions are especially useful in bakery products, where they provide exceptional results when used as egg substitutes, while adding valuable nutrients to the products into which they are incorporated.

### FIELD OF THE INVENTION

The invention relates to food ingredient compositions which may be used to supplement, or substitute for, eggs, fats, gums, starches, dough conditioners, emulsifiers, and other food ingredients, while providing desirable nutritional properties and taste, texture, and consistency properties.

### BACKGROUND OF THE INVENTION

China is the world's largest producer of eggs, with the United States being the second largest egg producer. In the U.S. alone, approximately 91.9 billion eggs were produced and sold in 2011, according to the U.S. National Agriculture Statistics Service. Eggs are generally sold as “shell eggs,” which are the familiar in-shell form consumers purchase at a market or grocery store, or “breaker eggs”—sold in liquid, powdered, or frozen form. Powdered egg products are commonly used in food processing and manufacturing. Egg products generally comprise egg, egg yolk, egg albumin, egg powder, or a combination thereof.

In the bakery and food production industries, eggs serve a variety of purposes, including aeration of cakes and meringues, emulsification of oils in mayonnaise, pastry glazing, serving as a binder in cakes, providing coagulation in quiches, and thickening custards, for example.

Egg substitutes have been under development for a number of years for a variety of reasons. For example, many individuals are allergic to eggs and egg products. The supply of eggs is subject to disruption by weather-related events and by viruses, fungi and other microorganisms (such as Salmonella bacteria) that may either harm the chicken or the consumer who ultimately purchases the egg. New regulations, particularly those implemented in Europe in recent years, have increased the amount of space required for housing chickens used for egg production, and the consumer desire for free-range chicken products has increased the cost to house and feed chickens in those facilities. Furthermore, bulk-pasteurized eggs and fresh are difficult to handle and have limited shelf life. They must be stored under refrigerated conditions, and therefore require significant space in a food production facility.

Egg substitutes have, over the years, incorporated a number of different proteins, carbohydrates, oils, and other compositions. Egg substitutes listed on websites promoting vegetarian or vegan diets, for example, include potato starch, tapioca flour, cellulose gum, mashed potatoes, canned pumpkin, squash, pureed fruit (e.g., prunes), ground flax seed, agar powder, soy yogurt, soy flour, buttermilk, arrowroot powder, and a mixture of vinegar and baking powder. However, many of those egg substitutes only substitute for a portion of the egg (the yolk, mostly fat and lecithin, an emulsifier) and still require the white (albumen protein) or they may require the addition of eggs, egg powder, etc., but allow the use of less egg product in, for example, baked goods. Some egg substitutes are only suitable for use in a limited line of products. For example, an egg substitute that works satisfactorily in a pumpkin pie may not produce a muffin that would have the desired characteristics. Flax seed has previously been used as an egg substitute by using one tablespoon flax seeds, measured before grinding, mixed with three tablespoons of water to replace one egg. However, when ground flax seed alone is used as the egg replacement, it produces what has been described as an “earthy”, “green,” or “grassy” taste. Whey protein has also been used as an egg substitute, but the recommended method of use is to replace only 50 percent of the egg with whey protein and utilize egg (shell egg, liquid, dried, etc.) for the other 50 percent. Other egg substitutes provide sufficiently acceptable results for individuals who want to avoid the use of eggs entirely, such as vegans, but do not provide similar enough results to those of eggs to be widely accepted by the average consumer. Clearly, certain egg substitutes that have been suggested may also have limited use because, particularly in the case of fruit purees, they impart a particular taste that may not be desirable in the final product.

What are needed are egg substitutes that do not require the use of eggs, egg yolks, egg albumen, or egg powder, but produce a product having properties that would be expected of an egg-containing product. What would be even more beneficial would be the development of multi-use products that could not only be used as egg substitutes, but also as substitutes for fats, emulsifiers, and other ingredients that affect the taste and consistency of foods. Even more desirable would be multi-use products which might contribute desirable nutritional benefits as well as possess the desired properties to provide a substitute for eggs, egg yolks, fats, emulsifiers, etc., that would be met with high consumer acceptance.

### SUMMARY OF THE INVENTION

The present invention relates to compositions comprising a first component comprising a significant source of protein and a second component comprising at least one plant seed or fraction thereof and a second component comprising at least one plant seed or fraction thereof which provides an effective amount of functional properties from gum, starch, soluble and insoluble fiber, carbohydrates, fat and protein to provide an effective hydrocolloidal system. In various aspects, a first component comprising a significant source of protein and a second component comprising at least one plant seed or fraction thereof which provides an effective amount of gum and protein, may be present in a ratio from about 1:1 to about 1:3. In some aspects, the first component may be a milk-derived protein selected from the group consisting of milk protein concentrate, whey protein concentrate, milk protein isolate, whey protein isolate, calcium caseinate, sodium caseinate, rennet casein, acid casein, lactoferrin, and combinations thereof. The first component may also comprise plant proteins provided by pea, rice, chia, soy, amaranth, teff, millet, oats, and combinations thereof.

Aspects of the invention may comprise compositions comprising milk-derived protein and flax seed, for example. Compositions of the invention also comprise whey protein concentrate, flax seed, and calcium caseinate.

The invention also provides a method for producing a food product without eggs, or with a reduced egg content, the method comprising substituting a composition comprising a first component comprising a significant source of protein and a second component comprising at least one plant seed or fraction thereof which provides an effective amount of functional properties from gum, starch, soluble and insoluble fiber, carbohydrates, fat and protein to provide an effective hydrocolloidal system to provide an effective substitute for shell eggs, liquid eggs, powdered eggs, or fractions or combinations thereof. In various aspects of the method a first component comprising a significant source of protein and a second component comprising at least one plant seed or fraction thereof which provides an effective amount of functional properties from gum, starch, soluble and insoluble fiber, carbohydrates, fat and protein to provide an effective hydrocolloidal system, may be present in a ratio from about 1:1 to about 1:3. In some aspects, the first component may be a milk-derived protein selected from the group consisting of milk protein concentrate, whey protein concentrate, milk protein isolate, whey protein isolate, calcium caseinate, sodium caseinate, rennet casein, acid casein, lactoferrin, and combinations thereof. The first component may also comprise plant proteins provided by pea, rice, chia, soy, amaranth, teff, millet, oats, and combinations thereof.

Aspects of the method may comprise substituting compositions comprising milk-derived protein and flax seed, for example. Compositions of the invention also comprise whey protein concentrate, flax seed, and calcium caseinate.

The invention also provides a method for using a multi-purpose composition to substitute for eggs, fats, gums, starches dough conditioners, and/or emulsifiers when used as an ingredient in food products such as breads, cakes, cooked vegetable patties, salad and other dressings, and gluten-free products, and a method for forming a binder, wash, or coating for a food product, the method comprising admixing a composition comprising a first component comprising a significant source of protein and a second component comprising at least one plant seed or fraction thereof which provides an effective amount of functional properties from gum, starch, soluble and insoluble fiber, carbohydrates, fat and protein to provide an effective hydrocolloidal system, to produce a product which binds together or coats food ingredients or acts as an effective substitute for eggs, fats, gums, starches dough conditioners, and/or emulsifiers when used as an ingredient in food products such as breads, cakes, cooked vegetable patties, salad and other dressings, and gluten-free products. In various aspects of the method a first component comprising a significant source of protein and a second component comprising at least one plant seed or fraction thereof which provides an effective amount of functional properties from gum, starch, soluble and insoluble fiber, carbohydrates, fat and protein to provide an effective hydrocolloidal system, may be present in a ratio from about 1:1 to about 1:3. In some aspects, the first component may be a milk-derived protein selected from the group consisting of milk protein concentrate, whey protein concentrate, milk protein isolate, whey protein isolate, calcium caseinate, sodium caseinate, rennet casein, acid casein, lactoferrin, and combinations thereof. The first component may also comprise plant proteins provided by pea, rice, chia, soy, amaranth, teff, millet, oats, and combinations thereof.

Aspects of the method may comprise substituting compositions comprising whey protein concentrate and flax seed, with calcium caseinate optionally added, for eggs, fats, gums, starches dough conditioners, and/or emulsifiers when used as an ingredient in food products such as breads, cakes, cooked vegetable patties, salad and other dressings, and gluten-free products.

### BRIEF DESCRIPTION OF THE DRAWINGS

FIG. 1A is a photograph of a cross-section of a muffin prepared with a composition of the invention (Optisol® 3000), and FIG. 1B is a photograph of a cross-section of a muffin prepared with dried whole egg.

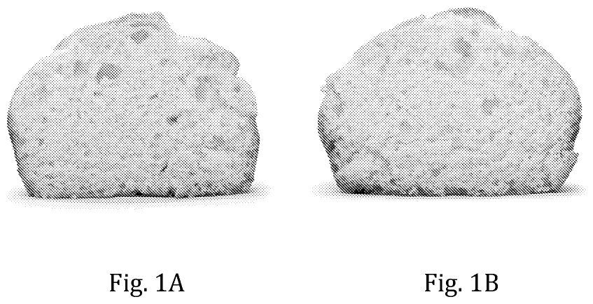

FIG. 2 is made up of two photographs of black bean burgers made using soy protein (control—FIG. 2A) and Optisol® 3000 (FIG. 2B). As the photograph illustrates, the size, texture, and consistency of the black bean burger made with Optisol® 3000 is significantly improved over that of the control.

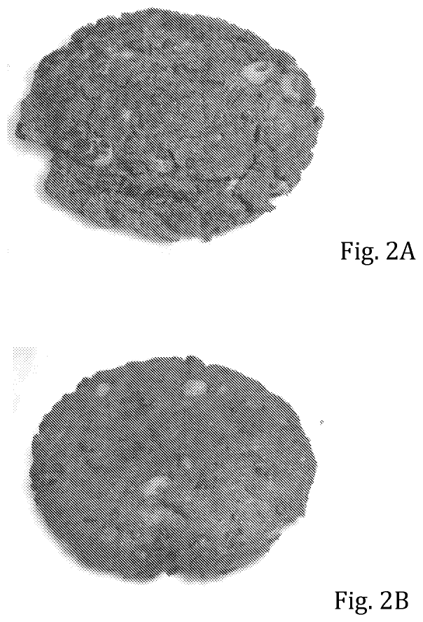

FIG. 3A is a photograph of a slice of French toast made with a coating composition containing egg (control) and FIG. 3B is a photograph of a slice of French toast made with a coating composition containing Optisol® 3000 (eggless).

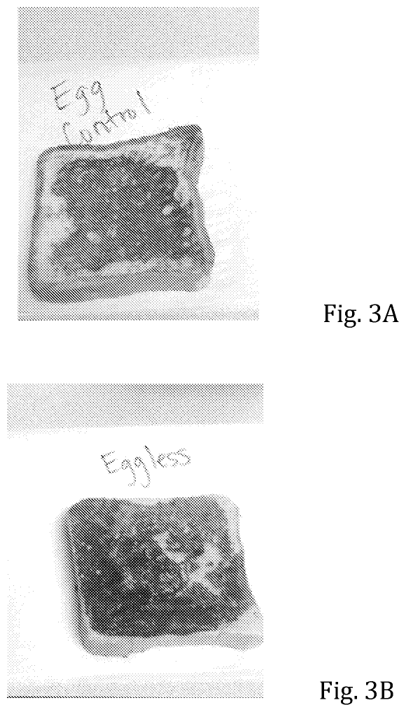

### DETAILED DESCRIPTION

When many consumers think of “healthier” versions of foods, what first comes to their minds is usually not an equally pleasant—or better—taste, texture, mouthfeel, and/or other sensory property. Instead, “healthy” foods are often associated with phrases like “tastes like cardboard” or “it has to be good for me, because it tastes bad.” Various ingredients have been found to be useful for replacing cholesterol-rich ingredients, fats and/or oils, for example, but in many cases the modified products compare unfavorably with the original, except where cholesterol levels, fat levels, salt levels, etc., are concerned. However, the inventors have developed a product that not only provides a healthier option for replacing certain ingredients—most notably eggs, but also gluten, emulsifiers, fats/oils, etc.—in a variety of foods, but also does that while creating products that test panels have selected as even more flavorful, having a better texture, etc., than the comparable product which may contain eggs, fats, and other ingredients that many are trying to restrict in their diets.

As used herein, a “significant source of protein” is defined as a source of protein that provides, or is enriched to provide, at least about 35 percent edible protein suitable for human nutrition. Where the term “comprising” is used, it is to be understood that the terms “consisting of” and “consisting essentially of” may also be used. For convenience, the terms “Optisol 3000,” Optisol® 3000,” “Optisol 3050,” “Optisol® 3050,” etc., are used to denote compositions of the invention. An “effective hydrocolloid system” produces a desired texture and consistency.

Compositions of the invention comprise a combination, such as an admixture or blend, comprising a first component comprising a significant source of protein and a second component comprising at least one plant seed or fraction thereof which provides an effective amount of functional properties from gum, starch, soluble and insoluble fiber, carbohydrates, fat and protein to provide an effective hydrocolloidal system to promote the effective substitution of the inventive composition for eggs, fats, gums, starches dough conditioners, and/or emulsifiers when used as an ingredient in food products such as breads, cakes, cooked vegetable patties, salad and other dressings, and gluten-free products. In various aspects, a first component comprising a significant source of protein and a second component comprising at least one plant seed or fraction thereof which provides an effective amount of functional properties from gum, starch, soluble and insoluble fiber, carbohydrates, fat and protein to provide an effective hydrocolloidal system, may be present in a ratio from about 1:1 to about 1:3. The second component is selected to provide an effective amount of gum, carbohydrates, soluble and insoluble fiber, with sufficient hydrocolloid properties to promote the desired synergistic effect when combined with the first component. In some aspects, the first component may be a milk-derived protein selected from the group consisting of milk protein concentrate, whey protein concentrate, milk protein isolate, whey protein isolate, calcium caseinate, sodium caseinate, rennet casein, acid casein, lactoferrin, and combinations thereof. The first component may also comprise plant proteins provided by pea, rice, chia, soy, amaranth, teff, millet, oats, and combinations thereof.

Aspects of the invention may comprise compositions comprising milk-derived protein and flax seed, for example. The inventors have found that an especially effective product for egg replacement, use in gluten-free products, substitution for fats/oils, emulsification, binding, etc., is a milk-derived protein, such as, for example, whey protein concentrate, and milled flax seed, to which calcium caseinate may also be added.

In various aspects of the invention, the second component comprising at least one plant seed or fraction thereof may comprise flax seed, where flax seed may more broadly be defined as ground flax seed, milled flax seed, or compositions derived from ground or milled flax seed, such as defatted milled flax, partially defatted milled flax, flax gum, milled flax, heat-treated milled flax or flaxseed, and/or flax protein. However, it will be understood and appreciated by one of skill in the art, given the present disclosure and the examples herein, that a variety of plant seeds may possess the desired characteristics to provide a second component of the composition, that is, comprising an effective amount of functional properties from gum, starch, soluble and insoluble fiber, carbohydrates, fat and protein to provide an effective hydrocolloidal system function in bakery and other food systems. For example, chia seed, and other seeds can have an appropriate gum profile to provide a result similar to that of flax seed (e.g., Linum usitatissimum). A variety of such seeds have previously been identified and disclosed by Tookey and Jones (H. L. Tookey and Quentin Jones, New Sources of Water-Soluble Seed Gums, Economic Botany, April-June 1965, Volume 19, Issue 2, p. 165-174).

Proteins which the inventors have found to produce especially good results for multi-purpose use of the inventive compositions in bakery products, dressings, bean or vegetable burger patties, etc., include milk-derived proteins selected from the group consisting of milk protein concentrate (MPC), whey protein concentrate (WPC), milk protein isolate (MPI), whey protein isolate (WPI), calcium caseinate, sodium caseinate, rennet casein, acid casein, lactoferrin, and combinations thereof. Defatted milled flax seed is also especially effective for producing compositions of the invention, particularly when admixed with whey protein concentrate. In various aspects, compositions of the invention comprise milk-derived protein and flax seed in a ratio of from about 1:1 to about 1:3, however, the ratio may be adjusted to provide higher ratios of the second component (e.g., flaxseed), as desired.

The method of the invention and compositions of the invention can provide for substitution of the egg ingredient without requiring that any egg be used as an ingredient, if desired, yet still provide the desirable qualities associated with the incorporation of egg as an ingredient of a food product. Desirable qualities provided by the use of compositions of the invention as ingredients include desirable cell structure in breads, cakes, and bakery items, desirable mouth feel, with decreased fat and emulsification characteristics that provide stable emulsification in the finished product. Compositions of the invention are useful in a variety of products from baked goods to salad dressings. They may be used as egg substitutes, emulsifiers, binders, oil/fat substitutes, coatings, washes, and combinations thereof. Given the variety of purposes for which the inventors have already demonstrated that these compositions may be used, it would be well within the scope of skill of one of skill in the art to envision additional uses for these compositions, given the excellent synergistic effects that are provided by the protein component and the plant/seed component.

Compositions of the invention may be incorporated as ingredients into a variety of baked goods, including but not limited to breads, cakes, muffins, and cookies. For baked goods such as these, compositions comprising a combination of whey protein and flax seed are especially effective. A whey protein concentrate or milk protein concentrate and flax seed combination, particularly when used as a combination in a ratio of from about 1:1 to about 3:1 milled flax seed to whey protein concentrate (WPC) or milk protein concentrate (MPC), has demonstrated particularly effective results in the preparation of baked goods having similar properties, such as appearance, color, fluffiness, flexibility, flavor, moisture, sweetness, and chewiness, for example, as of those baked goods prepared with whole eggs, dried eggs, or a combination thereof.

For washes, liquid coatings, binders for adherence of breading, etc., such as an egg wash for preparing French toast, compositions comprising a blend of milk protein concentrate and calcium caseinate with defatted milled flaxseed has been shown to be particularly effective, providing an eggless French toast product that is thin enough to dip the toast into without resulting in a soggy product.

Milk-derived proteins such as milk protein concentrate, calcium caseinate, whey protein, whey protein concentrate, and whey protein isolate are readily available commercially from a variety of sources. Flax protein and milled flax seed, as well as a variety of other plant seed products, are readily available from a variety of sources, as well. Those of skill in the art, given the disclosure of the present invention, may readily modify compositions of the invention in order to tailor them to specific products utilizing milk protein fractions or flax fractions to tailor egg replacement to the specific bakery application, or fat, oil, or emulsifier replacement to their respective applications. As shown in the Examples described herein, disclosed ingredient formulations are effective for producing excellent eggless products such as muffins, cornbread, cookies, and French toast. They have also been shown to provide desirable properties when incorporated into bean/vegetable burgers/patties, salad dressings, and gluten-free bread products.

Compositions of the invention will be especially useful for consumption by individuals who are allergic to eggs and fractions thereof. Compositions of the invention provide the advantage of being easily produced and transported in powder form, decreasing costs and increasing shelf-life. Liquid formulations may also be produced, however, especially where such formulations may be needed for washes, coatings, etc.

When compared to egg protein, whey protein provides an excellent nutritional profile, having a protein efficiency ratio of 3.9, a biological value of 104, and net protein utilization of 92 (egg protein has a protein efficiency ratio of 2.2, a biological value of 74, and net protein utilization of 61). Recently, efforts have been made to increase the omega-3 fatty acid content of eggs by feeding the hens flax seed. Compositions of the present invention provide an excellent source of omega-3 fatty acids through the flax seed, while also providing all the essential amino acids via milk protein, especially when whey protein is used. When combined, they therefore not only provide a composition with nutritional benefits as good as, if not better, than those provided by eggs, but also act synergistically to provide desirable effects that are better than those produced by either whey protein or flax seed alone. A nutritional comparison between comparable amounts of a composition of the invention (Optisol® 3000) and dried whole egg is provided in Table 1.

TABLE 1

| | Optisol® 3000 | | Dried Whole Egg | |
|---|---|---|---|---|
| Calories | 419 | g | 582 | g |
| Protein | 47.6 | g | 46.0 | g |
| Carbohydrates | 29.5 | g | 4.9 | g |
| Total Fat | 12.4 | g | 40.0 | g |
| Saturated Fat | 2.6 | g | 12.5 | g |
| Cholesterol | 147 | mg | 1477 | mg |
| Dietary Fiber | 28.6 | g | 0.0 | g |

The invention will be further described by means of the following non-limiting examples.

### EXAMPLES

### Muffins

In total, 7 different types of muffins were produced for use on the texture analyzer following this analysis, 4 different combinations were brought forward for sensory analysis. Formulations used in the muffin analysis are shown in Tables 2-4 below.

TABLE 2
Muffins - Composition

| | Whole Egg | Dry Egg | Flax:WPC | Flax:WPC |
|---|---|---|---|---|
| Ingredients | (g) | (g) | (2:1) (g) | (1:1) (g) |
| Muffin Mix | 195.89 | 198.42 | 198.42 | 198.42 |
| Water | 98.36 | 114.58 | 114.58 | 114.58 |
| Whole Egg | 20.75 | 0.00 | 0.00 | 0.00 |
| Dry Egg | 0.00 | 2.00 | 0.00 | 0.00 |
| Flax (defatted, | 0.00 | 0.00 | 1.33 | 1.0 |
| milled) | | | | |
| WPC | 0.00 | 0.00 | 0.67 | 1.0 |
| Total | 315.00 | 315.00 | 315.00 | 315.00 |

In addition to the above formulations, three other types of muffins were made: a muffin using only WPC to replace the egg; one using only flax to replace the egg; and a muffin using just a muffin mix and water to replace the egg. The same cooking procedure was used for each formulation. Briefly, the oven was preheated to 400° F. and ingredients were weighed out in separate bowls. Ingredients were mixed together and whisked for 30 seconds. The mix was poured into a pre-greased tray for muffins, adding 50 g of the mixture to each muffin cup. Trays were placed in the oven for 22 minutes. Upon removal from the oven, trays were left to stand for 2 minutes. Muffins were removed from each tray and allowed to cool on a wire rack. Texture analysis was performed 60 minutes later, when muffins were a room temperature.

### Textural Analysis

Muffins were analyzed primarily on firmness and elasticity. The TA.XT2 texture analyzer was used in conjunction with the standard AIB muffin firmness and elasticity method, which measures firmness at two depths (6.25 and 7 mm) and then measures residual firmness after 30 seconds hold time. The force calculated over the 30 second hold time was then divided by the initial force to give a measurement of elasticity. The probe used for measurement was a 36 mm cylinder probe with radius*(P/36R) using 5 kg load cell, calibrated for force and for height (30 mm) before tests were commenced.

The top of the muffin was removed with a knife, and the muffin was placed under the cylinder probe to begin the test. Results were automatically calculated and recorded by the TA.XT2 computer program. A sample set in the range of 22-36 was tested for each treatment.

### Sensory Analysis:

Twelve different panelists were asked to judge each sample based on several attributes, and indicate the intensity of each attribute by marking the appropriate box. Each muffin was given its own individual 3 digit code so panelists were unable to identify the treatments.

The following muffins were selected for sensory trials: 2:1 blend of flax: WPC; 1:1 blend of flax: WPC; whole egg muffin; and dry egg muffin. Statistical analysis was then carried out on both the texture analysis and the sensory analysis using Statistica Version 10′ using a one-way ANOVA with P values set at ≤0.05.

Results demonstrated that a flax and WPC combination mixed into a standard recipe for muffins will produce a muffin almost identical to that of a dry egg muffin. It is essential to get an egg replacement to meet the sensory properties, as well as texture properties, that define a ‘muffin’. As shown in Table 3, flax and WPC can be used together to give the characteristics desirable in an egg-containing muffin. No significant difference was identified for muffins prepared with the flax and WPC combination and those prepared with dry and whole egg. This taste panel sampled two different forms of the flax and WPC blend and results demonstrated no significant difference between the two muffin formulations using flax: WPC 1:1 or 2:1.

TABLE 3
Muffins - Sensory Data

| | Whole Egg | Flax:WPC (2:1) | Dry Egg | Flax:WPC (1:1) |
|---|---|---|---|---|
| Appearance | 7.50 | 6.83 | 7.33 | 6.67 |
| Color | 7.42 | 6.92 | 7.17 | 6.92 |
| Fluffiness | 5.83 | 5.17 | 6.75 | 6.00 |
| Flavor | 6.75 | 5.75 | 6.75 | 5.75 |
| Aftertaste | 6.50 | 5.67 | 6.42 | 5.67 |
| Crust | 6.17 | 5.42 | 6.25 | 6.25 |
| Toughness | | | | |
| Moisture | 5.00 | 6.50 | 5.58 | 5.92 |
| Overall Liking | 7.00 | 6.08 | 6.92 | 6.00 |

### Corn Bread

Six different types of corn breads were produced for use on the texture analyzer and, following this analysis, three different combinations were used for sensory analysis. Formulations used in the corn bread analysis are shown in Table 4 below.

TABLE 4
Cornbread Composition

| | Whole Egg | Flax:WPC | Dry Egg | Mix Only | Flax Only | WPC Only |
|---|---|---|---|---|---|---|
| Ingredients | (g) | (2:1) (g) | (g) | (g) | (g) | (g) |
| Cornbread mix | 288.00 | 292.06 | 292.06 | 295.22 | 292.02 | 292.02 |
| Milk | 108.66 | 108.66 | 108.66 | 108.66 | 108.66 | 108.66 |
| Vegetable oil | 54.33 | 54.33 | 54.33 | 54.33 | 54.33 | 54.33 |
| Egg | 33.33 | 0.00 | 0.00 | 0.00 | 0.00 | 0.00 |
| Flax:WPC 2:1 | 0.00 | 3.21 | 0.00 | 0.00 | 0.00 | 0.00 |
| Dry Egg | 0.00 | 0.00 | 3.21 | 0.00 | 0.00 | 0.00 |
| Flax Only | 0.00 | 0.00 | 0.00 | 0.00 | 3.20 | 0.00 |
| WPC Only | 0.00 | 0.00 | 0.00 | 0.00 | 0.00 | 3.20 |
| Water | 0.00 | 26.05 | 26.05 | 26.10 | 26.10 | 26.10 |
| Total | 484.32 | 484.31 | 484.31 | 484.31 | 484.31 | 484.31 |

WPC-only corn bread, a flax-only corn bread and a corn bread using just the corn bread mix were measured on the texture analyzer, but not included in sensory trials.

Cornbread samples were prepared using the same cooking/baking procedure. The oven was preheated to 400° F. and ingredients were weighed out into separate bowls. Ingredients were mixed together and whisked for 30 seconds. Mix was poured into a pre-greased tray, adding 180 g of the mixture to each. Trays were placed in the oven for 35 minutes, then removed from the oven and allowed to stand for 2 minutes.

Cornbread was removed from the tray and allowed to cool on wire rack. Texture analysis was performed after products were cooled for 40 minutes.

### Texture Analysis:

The most important consideration in making corn bread was the firmness of the bread. The TA.XT2 texture analyzer was used to determine bread firmness using the AACC (74-09) standard method. The probe compresses the sample until it has compressed it by 40% of the product height, withdraws from the sample, and returns to its starting position. Consistent sample preparation is important for the test to be accurate. Sample was prepared by cutting 1-inch thick slices, one slice for each test sample, and discarding the end crust slices of the loaves. The probe used for this measurement was a 36 mm cylinder probe with radius*(P/36R) using 5kg load cell, calibrated for force and height (30 mm) before the tests were performed. Samples were then placed under the probe for analysis. A sample set in the range of 22-36 was tested for each treatment. Results were automatically calculated and recorded by the TA.XT2 computer program.

### Sensory Analysis:

A similar taste test was given to 10 different panelists, who were asked to judge each sample of cornbread based on a number of different attributes and indicate the intensity of each attribute by marking the appropriate box. The cornbread formulations used for sensory trials were the 2:1 blend of flax: WPC, whole egg cornbread, and dry egg cornbread. Each corn bread was given a distinct 3-digit code so panelists were unable to identify the treatments.

Statistical analysis was carried out on both the texture analysis and the sensory analysis using Statistica Version 10′ using a one-way ANOVA, with P values set at ≤0.05.

Table 5 illustrates the favorable results obtained in terms of using flax and WPC together as a suitable egg replacer for cornbread. What is clear from the results is that it is only when the two (flax and WPC) are combined, a baked product is produced that is similar to the dry egg control. When WPC is used on its own the firmness of the product is increased, and when flax is used solely as an egg replacer the firmness is decreased. If the egg is not substituted with a suitable replacement, the result is reduced cornbread firmness.

TABLE 5
Cornbread - Sensory Data

| | Whole Egg | Flax: WPC (2:1) | Dry Egg |
|---|---|---|---|
| Appearance | 7.50 | 6.40 | 7.70 |
| Color | 7.10 | 6.30 | 7.70 |
| Fluffiness | 6.90 | 6.20 | 6.70 |
| Flavor | 6.80 | 7.10 | 6.30 |
| Aftertaste | 6.30 | 6.40 | 5.80 |
| Grainy Texture | 6.40 | 7.30 | 7.00 |
| Moisture | 6.30 | 7.10 | 5.70 |
| Overall Liking | 7.10 | 7.20 | 6.30 |

### Cookies

Six different types of cookies were produced for use on the texture analyzer. Following the analysis, four of those formulas were used for sensory analysis. Formulations used in the cookie analysis are shown in Table 6.

TABLE 6
Cookies - Composition

| | | | | Negative | | |
|---|---|---|---|---|---|---|
| | Whole Egg | Flax:WPC | Dry Egg | Control | Flax Only | WPC Only |
| Ingredient | (g) | 2:1 (g) | (g) | (g) | (g) | (g) |
| All-Purpose Flour | 143.91 | 149.18 | 149.18 | 153.36 | 149.18 | 149.18 |
| Baking Soda | 1.42 | 1.42 | 1.42 | 1.42 | 1.42 | 1.42 |
| Salt | 1.42 | 1.42 | 1.42 | 1.42 | 1.42 | 1.42 |
| Unsalted Butter | 70.08 | 70.08 | 70.08 | 70.08 | 70.08 | 70.08 |
| (Softened) | | | | | | |
| Granulated Sugar | 46.94 | 46.94 | 46.94 | 46.94 | 46.94 | 46.94 |
| Brown Sugar | 51.62 | 51.62 | 51.62 | 51.62 | 51.62 | 51.62 |
| Vanilla Extract | 1.34 | 1.34 | 1.34 | 1.34 | 1.34 | 1.34 |
| Eggs | 43.27 | 0.00 | 0.00 | 0.00 | 0.00 | 0.00 |
| Dry egg | 0.00 | 0.00 | 4.18 | 0.00 | 0.00 | 0.00 |
| Flax | 0.00 | 0.00 | 0.00 | 0.00 | 4.18 | 0.00 |
| WPC | 0.00 | 0.00 | 0.00 | 0.00 | 0.00 | 4.18 |
| Flax:WPC 2:1 | 0.00 | 4.18 | 0.00 | 0.00 | 0.00 | 0.00 |
| Blend | | | | | | |
| Water | 0.00 | 33.83 | 33.83 | 33.83 | 33.83 | 33.83 |
| Total | 360.00 | 360.00 | 360.00 | 360.00 | 360.00 | 360.00 |

WPC-only cookies, flax-only cookies, and cookies using just the all-purpose flour were measured on the texture analyzer. Cooking procedures for all formulas were the same. Briefly, the oven was pre-heated to 375° F. Flour, baking soda and salt were combined by hand, using a spoon. Butter, sugar and vanilla were beaten with electric hand mixer on low speed for 2 minutes. Egg or protein and water were added and mixed, using an electric hand mixer on low speed for 1 minute. The flour mixture was gradually added and mixed with an electric hand mixture on low speed for 1 minute and 30 seconds. A scoop was used to remove the dough and place it in a ball shape on a sheet of parchment paper placed on a baking tray. Cookies were baked for 13 minutes. Texture analysis was performed after cookies had cooled for 60 minutes.

### Texture Analysis:

The TA.XT2 was set up with two adjustable supports of the rig base plate placed a suitable distance apart to support the sample. The sample was placed centrally over the supports just prior to testing. Once the trigger force was attained, the force was seen to increase until such time as the biscuit/cookie fractured and fell into two pieces. This is observed as the maximum force and can be referred to as the ‘hardness’ of the sample. The distance at the point of break is the resistance of the sample to bend and so relates to the flexibility.

The probe used for this measurement was a 3-Point Bending Rig (HDP/3PB) using 5 kg load cell. A sample set in the range of 22-36 was tested for each treatment.

### Sensory Analysis:

A similar taste test to that of the two previous sensory trials was given to 10 different panelists and they were asked to judge each cookie sample based on a number of different attributes and indicate the intensity of each attribute by marking the appropriate box. Cookies selected for sensory trials were those with a 2:1 blend of flax: WPC; a whole egg cookie; and a dry egg cookie. Each cookie was designated with a separate 3-digit code so that panelists were not biased by the label/description.

### Statistical Analysis:

Statistical analysis was carried out on both the texture analysis and the sensory analysis using Statistica Version 10′ using a one-way ANOVA, with P values set at ≤0.05.

As shown in Table 7, the whey/flax blend produced the desirable characteristics for which eggs are usually included in cookies. One cookie attribute that is of significant importance to consumers is flexibility. When comparing the Flax: WPC cookie and the cookie made with dry egg, the results for flexibility were similar. Utilizing WPC in the cookie formulation decreases the flexibility of the cookie. Cookies made with a flax-only formulation were similar to the cookies made with dry egg in terms of flexibility, but the flax had a negative impact on the flavor and produced a much darker color in the baked product.

TABLE 7
Cookies - Sensory Data

| | Flax: WPC (2:1) | Whole Egg | Dry Egg |
|---|---|---|---|
| Appearance | 7.56 | 6.44 | 7.00 |
| Color | 7.00 | 6.11 | 6.89 |
| Flavor | 5.89 | 6.22 | 6.67 |
| Texture | 5.67 | 6.22 | 6.67 |
| Grassy Flavor | 3.22 | 1.67 | 1.56 |
| Sweetness | 4.67 | 4.67 | 4.67 |
| Chewiness | 4.67 | 5.11 | 5.22 |
| Overall Liking | 6.00 | 6.22 | 7.11 |

Table 7 lists the mean scores out of a sum total of 9 for each of the different attributes, with results being similar across all attributes—illustrating the similarity of the results provided by the Flax:WPC composition to those of egg. While the dry egg scores better than the Flax: WPC combination, there is still no significant difference when comparing this attribute using the LS Means method with the P value set at 0.05. Although tasters were able to detect a “grassy” flavor in the flax and WPC blend, it did not significantly impact on their overall liking of the cookie. Other fractions of flax may be used to reduce the grassy note. Results for overall liking, across all treatments, showed no significant difference. Another important consideration is that the appearance and color of the flax: WPC cookies scored better than the cookie made with whole egg and the cookie made with dry egg.

### French Toast

A blend of milk protein concentrate, calcium caseinate and flax protein produces a suitable eggless French toast mix. It is thin enough to dip the toast in, and yet does not soak up enough water to cause spreading during cooking or make the bread soggy. The cook-time and color were suitably similar to the control. Blending the flax with the more neutral-flavored milk protein gives the product a cleaner flavor than flax alone, while the flax provides good textural properties.

TABLE 8
Coating Composition for French Toast

| Ingredient | Grams |
|---|---|
| Milk Protein Concentrate/ Ca | 7.5 |
| Caseinate Blend | |
| Powdered Canola Shortening | 6.5 |
| (w/maltodextrin) | |
| Gum Blend | 0.4 |
| Citric Acid | 0.5 |
| Cinnamon | 0.35 |
| Sugar | 8 |
| Flax Protein | 14 |
| Flavors | 1.15 |

### Panettone Bread—Replacement of Liquid Egg Yolk

Replacement 1:0.8 of liquid egg yolks with milk protein/flax composition of the invention (Optisol® 3000) in a Panettone Italian cake was performed as shown in Table 9.

TABLE 9
Panettone Bread Ingredients

| | | | Product With | |
|---|---|---|---|---|
| | Product With Egg Yolk | | MPC/Flax (Optisol?+0- | |
| | (Control) | | 3000) | |
| Ingredients | Gram | Weight % | Gram | Weight % |
| Bread Flour | 350.0 | 39.30 | 350.0 | 39.57 |
| Water | 270.0 | 30.32 | 270.0 | 30.53 |
| Granulated Sugar | 75.00 | 8.42 | 75.00 | 8.48 |
| Golden Currants | 50.00 | 5.61 | 50.00 | 5.65 |
| Dried Cranberries | 50.00 | 5.61 | 50.00 | 5.65 |
| Canola Oil | 40.00 | 4.49 | 40.00 | 4.52 |
| Liquid Egg Yolks | 30.00 | 3.37 | | |
| or | | | | |
| Optisol®-3000 | | | 24.00 | 2.71 |
| Active Bakers | 10.00 | 1.12 | 10.00 | 1.13 |
| Yeast | | | | |
| Cream Vanilla Flay | 7.00 | 0.79 | 7.00 | 0.79 |
| Salt | 6.00 | 0.67 | 6.00 | 0.68 |
| Nat Orange Flavor | 2.50 | 0.28 | 2.50 | 0.28 |

The OptiSol® 3000 was not prehydrated, but based on the whole egg yolk conversion to dry egg (49% water-51% solids), up to 43 grams of additional water may be added to the OptiSol® 3000 formula. Both formulas were mixed with a dough hook for 3 minutes 30 seconds. The doughs were then kneaded by hand for approximately 5 minutes. The doughs were placed in a metal bowl, covered, and proofed at 200 degrees F. for 2 hours. The doughs were punched down, weighed and reformed into the Panettone pans, then proofed for an additional hour to develop the flavors. The Panettones were then baked in a traditional non-convection oven at 350 degrees F. for 45 minutes. After cooling the Control and Test breads were taken out of the pans, weighed for bake loss, and sliced in half to measure peak height for comparison.

At 1:1 liquid egg yolk replacement, the color of the control is the typical Panettone yellow color provided with egg yolk, while the test bread had a darker, but not undesirable, color. Commercial Panettone breads usually have Beta Carotene added for color, which would be easily accomplished in the Optisol® 3000 product, as well. Bread height was 4 inches for the Control and 3 inches for the Test bread. While the Test bread was more dense, the control bread was drier and tougher compared to the Test bread. Both had good even cell structure showing equal emulsification properties. The bake loss on the Control bread was 9.09% compared to 3.93% on the OptiSol® 3000 bread.

A sensory panel was carried out with a Control (Liquid Egg Yolks) and the OptiSol® 3000 product at 80% by weight. A blind panel was used with eleven participants. Overall acceptance of the OptiSol® 3000 Panettone Bread (4.5) was higher than the Control (4.0).

### Gluten-Free Ancient Grain Muffins

A milk protein/flax product (Optisol® 3000) was compared to tapioca starch and to guar gum in a gluten-free muffin product. Ingredients were weighed (without pre-hydration) and mixed in a stainless bowl with a wire whisk for one minute. Muffin mix (90 grams) was placed into a paper cupcake mold and baked at 350 degrees F. for 22 minutes in a conventional oven. Muffin ingredients included, by weight, ancient grain blend (34.70), granulated sugar (9.91), sea salt (0.40), water (34.70), canola oil (4.96), Calrise (0.56), sodium bicarbonate (0.40), powdered natural vanilla flavoring (0.50), organic blue agave syrup (light) (4.96), semi-sweet chocolate chips (4.96), and 3.97 percent of either Optisol® 3000, tapioca starch, or guar gum.

### Eggless Sponge Cake

Formulas were set up for a basic sponge cake with the addition of the Control and OptiSol® 3000 at an addition rate of 4.0% and 1.5%. The batter was prepared by adding the water and then the dry ingredients, and mixing at low speed for 45 seconds. The specific gravity of the batter was measured and the batter poured into a greased 9-inch×13-inch pan. The cakes were cooked at 350 degrees F. in a convection oven for 30 minutes. After cooling, the cakes were measured for width and height (center & average sides). The OptiSol® 3000 cake was light and fluffy in texture, with large air pockets. The batter gave good rise and spread, and was moist with an eggless, sweet flavor. The final formula was achieved with no fat added and no starch or added emulsifiers other than the OptiSol® 3000 at 1.5%.

TABLE 10

| | | Height (Average | Height | |
|---|---|---|---|---|
| Formula | Specific Gravity | Sides) | (Center) | Width |
| Optisol® | 1.144 | 20 mm | 35 mm | 9.00'' |
| 3000 4% | | | | |
| Optisol® | 1.113 | 26 mm | 35 mm | 9.25'' |
| 3000 1.5% | | | | |
| Control | 1.144 | 23.5 mm | 35 mm | 9.50'' |

At the 4% whole egg replacement (1 to 1 on a dry basis) with OptiSol® 3000, the texture of the cake was very gummy and dense, although it had the same specific gravity as the egg control. At the 1.5% addition rate with OptiSol® 3000, the texture was very good and had the typical sponge cake consistency. The addition of Beta-Carotene provided a desirable egg-like color. The OptiSol® 3000 and the Control formulas all had a height of 35 mm, with the best cell structure. The OptiSol® 3000 cake had the most even spread and had good, even cell structure showing similar emulsification properties. The OptiSol® 3000 cake had the most shrinkage during cooking, possibly because of its higher protein content. However, results demonstrated that OptiSol® 3000 provides an attractive option for the replacement of both eggs and oils/fats in bakery products.

### Emulsification, Stabilization, and Fat Replacement in Honey Mustard Salad Dressing

Optisol® 3000, Optisol® 3050, and egg yolk were hydrated for ten minutes. Sugar, salt, and onion powder were added to the solution and allowed to hydrate for 5 minutes. Vinegars, Dijon mustard, honey, and lemon juice were added and allowed to hydrate for 3 minutes. Oil was then added with mixing, and the resulting product was homogenized at 2000 psi, then packaged.

Products with Optisol® 3000 and Optisol® 3050 demonstrated increased viscosity of the finished product, when compared to the control. The 3% Optisol® 3050 product maintained the same viscosity as the full-fat control. Lumifuge stability numbers for the three products were 0.3783 for control, 0.1157 for Optisol® 3000, and 0.0781 for Optisol® 3050, indicating that the Optisol® 3000 and Optisol® 3050 exhibited increased stability, as compared to the full-fat control.

### Binding and Texture-Enhancement in Bean/Vegetable Burger Patties

Soy was used as the control for comparison in these product comparisons, because the majority of vegetarian burgers on the market are produced using soy protein and/or textured vegetable protein (TVP). The patties were scaled to the same weight and formed between parchment paper using a patty press. In this formulation more soy was used than Optisol® 3000 to achieve the same level of protein content per sample. The OptiSol® patty was fried in canola oil at 350° F. for 1.5 minutes and removed to a sheet pan with a wire rack and placed on the rack for baking. The same process was followed for the soy patty, but the patty could not withstand the frying process. It was pan-fried in canola oil before being placed on the wire rack. The patties were then cooked in an oven at 425° F. until an internal temperature of 205° F. was reached. The patties were then cooled and frozen. They were reheated in the oven at 350° F. until the internal temperature reached 150° F. The patties were then measured for height and texture on the TA-TX Plus texture analyzer using the TA-44 probe attachment.

The OptiSol® patty appeared to have more consistent height and browning and was much more appealing overall. The average height of the OptiSol® patty was 15.1 mm, while the soy was 12.3 mm.

### Muffin Preparation—Protein Source Comparison

Chocolate chip muffins were prepared with addition of OptiSol® 3000 (Flaxseed, Whey Protein Concentrate) or Flaxseed/Pea Protein or Flaxseed/Rice Protein at an addition rate of 1.5%. Ingredients are shown in Table 11. The batter was prepared and 60 grams was placed into muffin cups and baked in randomized positions in a 24 cup muffin pan. An informal sensory panel was completed on nine different attributes. Texture analysis was used to quantify hardness on the muffins.

TABLE 11
Muffin Ingredients

| | Whey | Pea | Rice |
|---|---|---|---|
| | Amount | Amount | Amount |
| INGREDIENT | (%) | (%) | (%) |
| Whole Flour, All Purpose | 36.89 | 36.89 | 36.89 |
| Milk, Whole | 25.00 | 25.00 | 25.00 |
| Sugar, Granulated | 15.00 | 15.00 | 15.00 |
| Canola Oil | 7.50 | 7.50 | 7.50 |
| Water | 7.19 | 7.19 | 7.19 |
| Chocolate Chips, 4M Semi-Sweet 56% Silver | 5.00 | 5.00 | 5.00 |
| Butterbuds Cream Plus Vanilla, Natural Flavor | 0.70 | 0.70 | 0.70 |
| OptiSol 3000 (Flaxseed, Whey Protein | 1.50 | | |
| Concentrate) | | | |
| Flaxseed, Pea Protein, Roquette Natrally's | | 1.50 | |
| F85M | | | |
| Flaxseed, Rice Protein, Axiom 80% HZN | | | 1.50 |
| 12008-34 | | | |
| Baking Powder | 0.48 | 0.48 | 0.48 |
| Baking Soda | 0.44 | 0.44 | 0.44 |
| Salt | 0.30 | 0.30 | 0.30 |
| TOTAL | 100.00 | 100.00 | 100.00 |

Dry ingredients were weighed separately from liquid ingredients.

Mixing was completed in a stainless bowl with a whisk for 1 minute; chocolate chips were added and the muffin batter was whisked for an additional 30 seconds. 60 grams of batter was weighed into each muffin cup. The 3 treatments were randomly placed on the muffin pan. The muffins were baked in a 375° F. convection oven for 22 minutes. They were allowed to rest for 2 minutes in the muffin pan, then placed onto a cooling rack for 1 hour (remained in wax lined muffin cup liners through sensory testing).

Overall color and appearance was similar in all three treatments, with the Pea and Rice being slightly darker than the whey protein concentrate. All treatments had similar height, diameter and structure. The rice protein had some shrinkage as compared to the other 2 treatments. All cell structures were similar, with the pea protein having some larger air pockets and the rice protein the most uneven.

What is claimed is:

1. A method for replacing eggs in a bakery product, the method comprising substituting for dry eggs, on a 1:1 basis by dry weight, a composition comprising milled flaxseed and whey protein concentrate, wherein the ratio of milled flaxseed to whey protein concentrate in the composition is from about 1:1 to about 3:1.

2. The method of claim 1 wherein the bakery product is a bread.

3. The method of claim 1 wherein the bakery product is a muffin.

4. The method of claim 1 wherein the bakery product is a cookie.
